(19) United States
(12) Patent Application Publication
(10) Pub. No.: US 2019/0335878 A1
(43) Pub. Date: Nov. 7, 2019

(54) FOAM OF POLYURETHANE FOR USE IN COSMETIC APPLICATIONS

(71) Applicant: Covestro Deutschland AG, Leverkusen (DE)

(72) Inventors: Sebastian DÖRR, Düsseldorf (DE); Paula Cristina ALVES RODRIGUES, Düsseldorf (DE); Martin KRAUSE, Limburg (DE); Xiaohui XIONG, Shanghai (CN)

(21) Appl. No.: 16/349,436

(22) PCT Filed: Nov. 14, 2016
(86) PCT No.: PCT/CN2016/105721

§ 371 Date: May 13, 2019

(51) Int. Cl. A45D 34/04; B32B 5/24; B32B 5/02; B32B 27/06; B32B 29/00; A45D 33/00; A45D 40/26; B32B 5/18; B32B 27/40; C08G 18/73; C08G 18/48

(52) U.S. Cl. CPC A45D 34/04; C08G 2101/0083; B32B 5/022; B32B 27/065; B32B 29/007; A45D 33/00; A45D 40/26; B32B 5/18; B32B 27/40; C08G 18/73; C08G 18/48; A45D 2200/1036; B32B 2266/0278; B32B 2307/538; B32B 2307/54; B32B 2307/72; B32B 2555/00; B32B 5/245

(57) ABSTRACT

The use of a foam comprising polyurethane for cosmetic applications is provided. Process for applying a cosmetic component to a skin via the foam and a process for cleaning a part of a skin via the foam are provided too. An applicator as well as an envelope and a layered structure comprising the foam are shown.

The invention relates to a use of a foam comprising polyurethane for cosmetic applications. The invention further relates to a process for applying a cosmetic component to a skin via the foam, a process for cleaning a part of a skin via the foam, an applicator as well as an envelope comprising the foam and a layered structure comprising the foam.

There is always a need for articles suitable for the application of cosmetic components to the skin or hair of a user. Especially, materials which on the one hand side have the ability to absorb cosmetic components e.g. in the form of fluids or powders, but on the other hand side have the ability to spend these cosmetic components to a skin or hair of a user are favorable for the application of cosmetic components.

The present invention therefore deals with the provision of a suitable material to be used for the application of a cosmetic component to the skin or hair of a user. The material, especially the foam comprising polyurethane foam should therefore have fast and deep absorbance in respect of fluids or powders. Lastly, the material comprising the polyurethane foams shall also be cell-compatible, i.e., noncytotoxic, and optimally conform to the shape of the treated surface in use.

A first aspect of the invention is a use of a foam comprising a polyurethane, also named a polyurethane foam, for cosmetic applications on the skin or hair of a human or an animal. Cosmetic application in the sense of the invention means every contact of the foam with the skin or hair of a human or animal which represent a treatment in the field of personal care or toiletries. Not included are applications which are solely focused on a pharmaceutical treatment or application of a pharmaceutical. However, a combination of cosmetic and pharmaceutical application is preferably included in the meaning of cosmetic application. Examples of cosmetic applications are painting one's face, putting on lipstick, putting on eye make-up, putting on a face mask, cooling skin, relaxing skin, cleaning skin and/or hair, coloring hair, conditioning hair,

Preferably, the polyurethane is a hydrophilic, aliphatic polyurethane.

In a preferred embodiment the polyurethane is a hydrophilic, aliphatic polyurethane.

In a further preferred embodiment the foam is produced by reacting at least the following components:
A) isocyanate-functional prepolymers, obtainable by reaction of
   A1) low molecular weight aliphatic diisocyanates having a molar mass of 140 to 278 g/mol with
   A2) di- to hexafunctional, preferably tri- to hexafunctional, polyalkylene oxides having an OH number of 22.5 to 112, preferably 31.5 to 56, and an ethylene oxide content of 50 to 100 mol %, preferably of 60 to 85 mol %, based on the total amount of oxyalkylene groups present,
B) optionally alkali metal salts containing catalysts or alkali metal salts of weak inorganic acids,
C) water,
D) optionally heterocyclic 4-ring or 6-ring oligomers of low molecular weight aliphatic diisocyanates having a molar mass of 140 to 278 g/mol,
E) optionally further catalysts additionally to component B),
F) optionally surfactants,
G) optionally mono- or polyhydric alcohols, and
H) optionally hydrophilic polyisocyanates obtainable by reaction of component A and/or D) with
   H1) monofunctional polyalkylene oxides having an OH number of 10 to 250 and an ethylene oxide content of 50 to 100 mol %, based on the total amount of oxyalkylene groups present, wherein the reaction of component A) and/or D) with component H1) is established before the mixing with component C);
wherein the selected components are delivered, mixed, foamed and cured.

The absorbance of fluids, e.g. in form of physiological saline on the part of the polyurethane foams obtained by the process according to the present invention is typically in the range from 400 to 2000% (mass of absorbed fluid, divided by mass of dry foam; determination to DIN EN 13726-1, Part 3.2). Compared with other hydrophilic foams, therefore, the polyurethane foams can be used to achieve a very high absorption of fluids even without the use of superabsorbent polymers. It will be appreciated, however, that incorporation of superabsorbents is also possible with the polyurethane foams obtained by the process according to the present invention, although this is not preferable with these foams, since their absorption is already very high.

Preferably, the isocyanatefunctional prepolymers A) have a weight fraction of below 1.0 wt % for low molecular weight aliphatic diisocyanates having a molar mass of 140 to 278 g/mol, based on the total mass of the prepolymer.

In one further development of the invention, isocyanate-functional prepolymers A) having a weight fraction of below 1.0 wt %, preferably of below 0.5 wt %, for low molecular weight aliphatic diisocyanates having a molar mass of 140 to 278 g/mol, based on the prepolymer, are used. This content can be achieved through appropriately chosen use quantities of diisocyanates A1) and polyalkyene oxides A2). However, it is preferable for diisocyanate A1) to be used in excess in the subsequent separation, preferably by distillation, of unreacted diisocyanates. The polyurethane foams obtainable in this embodiment have a particularly low level of potentially harmful extractable constituents and hence are particularly highly cell-compatible.

The isocyanate-functional prepolymers A) are typically prepared by reacting 1 mol equivalent of polyalkylene oxides A2) with 1 to 20 mol, preferably 1 to 10 mol and more preferably 5 to 10 mol of diisocyanate A1). The reaction is typically carried out at 25 to 140° C., preferably 60 to 100° C. When excess diisocyanate was used, the subsequent removal of the excess is preferably effected by thin-film distillation.

Before, during and after the reaction or distillative removal of the excess diisocyanate, acidic or alkylating stabilizers, such as benzoyl chloride, isophthaloyl chloride, methyl tosylate, chloropropionic acid, HCl or antioxidants, such as di-tert-butylcresol or tocopherol can be added.

The isocyanate group content (determined by DIN EN ISO 11909) of the isocyanate-functional prepolymers A) is preferably in the range from 1.5 to 4.5 wt %, more preferably in the range from 1.5 to 3.5 wt % and even more preferably in the range from 1.5 to 3.0 wt %.

Examples of suitable low molecular weight aliphatic diisocyanates A1) are hexamethylene diisocyanate (HDI), isophorone diisocyanate (IPDI), butylene diisocyanate (BDI), bisisocyanatocyclohexylmethane (HMDI), 2,2,4-trimethylhexamethylene diisocyanate, bisisocyanatomethylcyclohexane, bisisocyanatomethyltricyclodecane, xylene diisocyanate, tetramethylxylylene diisocyanate, norbornane diisocyanate, cyclohexane diisocyanate or diisocyanatododecane, of which hexamethylene diisocyanate, isophorone diisocyanate, butylene diisocyanate and bis(isocyanatocyclohexyl)methane are preferred.

Preferably, exclusively hexamethylene diisocyanate (HDI), isophorone diisocyanate (IPDI) or mixtures thereof are used as low molecular weight aliphatic diisocyanates A1).

Polyalkylene oxides A2) are preferably copolymers of ethylene oxide and propylene oxide having an ethylene oxide content, based on the total amount of oxyalkylene groups present, of 50 to 100 mol %, preferably 60 to 85 mol %, and started on polyols or amines. Suitable starters of this kind are glycerol, trimethylolpropane (TMP), sorbitol, pentaerythritol, triethanolamine, ammonia or ethylenediamine.

The number-average molecular weight of the polyalkylene oxides A2) is typically in the range from 1000 to 15 000 g/mol and preferably in the range from 3000 to 8500 g/mol.

The polyalkylene oxides A2) can further have OH functionalities of 2 to 6, preferably of 3 to 6 and more preferably of 3 to 4.

Preferably, alkali metal salts of weak inorganic acids B) are used whose corresponding free acids have a pKₐ value of ≥4.0 and ≤14.0 in water at 25° C.

Potassium hydroxide, sodium hydroxide, potassium carbonate, sodium carbonate and sodium bicarbonate are examples of particularly suitable alkali metal salts of weak inorganic acids B), while any desired mixtures of at least two of these salts shall also be encompassed.

It is particularly preferable when the alkali metal salts of weak inorganic acids B) are selected from the group sodium hydroxide, sodium bicarbonate and sodium carbonate. A particularly short reaction time results in this case.

The water used C) can be used as such, as water of crystallization of a salt, as solution in a dipolar aprotic solvent or else as an emulsion. Preferably, the water is used as such or in a dipolar aprotic solvent. It is very particularly preferred to use water as such.

Optionally used ring oligomers D) are heterocyclic 4-ring or 6-ring oligomers of low molecular weight aliphatic diisocyanates having a molar mass of 140 to 278 g/mol such as isocyanurates, iminooxadiazinediones or uretdiones of the aforementioned low molecular weight aliphatic diisocyanates. Heterocyclic 4-ring oligomers such as uretdiones are preferred. The increased isocyanate group content due to the use of ring oligomers D) provides better foaming due to more CO₂ being formed in the isocyanate-water reaction.

To further accelerate the reaction, catalysts E) may be added. The catalysts in question are typically compounds with which a person skilled in the art is familiar from polyurethane technology. Preference here is given to compounds from the group consisting of catalytically active metal salts, amines, amidines and guanidines. Specific examples are dibutyltin dilaurate (DBTL), tin octoate (SO), tin acetate, zinc octoate (ZO), 1,8-diazabicyclo[5.4.0]undec-7-ene (DBU), 1,5-diazabicyclo[4.3.0]non-5-ene (DBN), 1,4-diazabicyclo[3.3.0]oct-4-ene (DBO), N-ethylmorpholine (NEM), triethylenediamine (DABCO), pentamethylguanidine (PMG), tetramethylguanidine (TMG), cyclotetramethylguanidine (TMGC), n-decyltetramethylguanidine (TMGD), n-dodecyltetramethylguanidine (TMGDO), dimethylaminoethyltetramethylguanidine (TMGN), 1,1,4,4,5,5-hexamethylisobiguanidine (HMIB), phenyltetramethylguanidine (TMGP) and hexamethyleneoctamethylbiguanidine (HOBG).

However, it is particularly preferable for no catalysts E) to be used.

Surfactants F) can be added to improve foam formation, foam stability or the properties of the resulting polyurethane foam, in which case such additives can in principle be any known anionic, cationic, amphoteric and nonionic surfactants and also mixtures of at least two thereof. Preference is given to using alkylpolyglycosides, EO-PO block copolymers, alkyl or aryl alkoxylates, siloxane alkoxylates, esters of sulfosuccinic acid and/or alkali or alkaline earth metal alkanoates. Particular preference is given to using EO-PO block copolymers, and very particularly preferably the EO-PO block copolymers are solely used as surfactants F).

In addition, mono- and polyhydric alcohols G) and mixtures thereof can be used to improve the properties of the resulting polyurethane foam. Examples of these alcohols are mono- or polyhydric alcohols or polyols, such as ethanol, propanol, butanol, decanol, tridecanol, hexadecanol, ethylene glycol, neopentyl glycol, butanediol, hexanediol, decanediol, trimethylolpropane, glycerol, pentaerythritol, monofunctional polyether alcohols and polyester alcohols, polyether diols and polyester diols as well as mixtures of at least two thereof.

The reaction can be carried out in the presence of urethanization catalysts such as tin compounds, zinc compounds, amines, guanidines or amidines, or in the presence of allophanatization catalysts such as zinc compounds.

The reaction temperature is typically in the range from 25 to 140° C. and preferably in the range from 60 to 100° C.

When excess low molecular weight diisocyanate was used, excess low molecular weight aliphatic diisocyanate is subsequently removed, preferably by thin film distillation.

Before, during and after the reaction or distillative removal of excess diisocyanate, acidic or alkylating stabilizers, such as benzoyl chloride, isophthaloyl chloride, methyl tosylate, chloropropionic acid, HCl or antioxidants, such as di-tert-butylcresol or tocopherol can be added.

The NCO content (determined to DIN EN ISO 11909) of hydrophilic polyisocyanates H) is preferably in the range from 0.3 to 20 wt %, more preferably in the range from 2 to 10 wt % and even more preferably in the range from 3 to 6 wt %.

Preparing polyalkylene oxides H1) by alkoxylating suitable starter molecules is literature known (e.g., Ullmanns Encyclopädie der technischen Chemie, 4th edition, volume 19, Verlag Chemie, Weinheim pp. 31-38). Suitable starter molecules are especially saturated monoalcohols such as methanol, ethanol, n-propanol, isopropanol, n-butanol, isobutanol, sec-butanol, diethylene glycol monobutyl ether and also aromatic alcohols such as phenol or monoamines such as diethylamine. Preferred starter molecules are saturated monoalcohols of the aforementioned kind. It is particularly preferable to use diethylene glycol monobutyl ether or n-butanol as starter molecules.

Monofunctional polyalkylene oxides for the purposes of the invention are compounds having just one isocyanate-reactive group, i.e., one group capable of reacting with an NCO group.

The monofunctional polyalkylene oxides H1) preferably have an OH group as isocyanate-reactive group.

The monofunctional polyalkylene oxides H1) have an OH number of 15 to 250, preferably of 28 to 112, and an ethylene oxide content of 50 to 100 mol %, preferably of 60 to 100 mol %, based on the total amount of oxyalkylene groups present.

The monofunctional polyalkylene oxides H1) typically have number-average molecular weights of 220 to 3700 g/mol, preferably of 500 to 2800 g/mol.

Preferably, the components A) to H) are used in the following amounts:

A) 100 parts by weight of isocyanate-functional prepolymers,
B) 0.01 to 5 parts by weight of alkali metal salts of weak inorganic acids,
C) 0.1 to 200 parts by weight of water,
D) 0 to 100 parts by weight of heterocyclic oligomers,
E) 0 to 1 part by weight of catalysts,
F) 0 to 10 parts by weight of surfactants,
G) 0 to 20 parts by weight of mono- or polyhydric alcohols, and
H) 0 to 60 parts by weight of hydrophilic polyisocyanates.

It is also advantageous when 10 to 100, preferably 20 to 90 and more preferably 20 to 80 parts by weight of heterocyclic oligomers D) are used.

The preferably hydrophilic, aliphatic polyurethane foams according to the invention can be prepared by mixing the components A), B), C) and optionally D), E), F), G) and H) in any order, foaming the mixture and curing, preferably by chemical crosslinking. The components A), D) and optionally H) are preferably premixed with each other. The components B) is preferably added to the reaction mixture in the form of their aqueous solutions. As mixing tools any mixing tools known to the person skilled in the art for mixing the mentioned components might be used.

Foaming can in principle be effected by means of the carbon dioxide formed in the course of the reaction of the isocyanate groups with water, but the use of further blowing agents is likewise possible. It is thus also possible in principle to use blowing agents from the class of the hydrocarbons such as C3-C6 alkanes, for example butanes, n-pentane, isopentane, cyclopentane, hexanes or the like, or halogenated hydrocarbons such as dichloromethane, dichloromonofluoromethane, chlorodifluoroethanes, 1,1-dichloro-2,2,2-trifluoroethane, 2,2-dichloro-2-fluoro-ethane, particularly chlorine-free hydrofluorocarbons such as difluoromethane, trifluoromethane, difluoroethane, 1,1,1,2-tetrafluoroethane, tetrafluoroethane (R 134 or R 134a), 1,1,1,3,3-pentafluoropropane (R 245 fa), 1,1,1,3,3,3-hexafluoropropane (R 256), 1,1,1,3,3-pentafluorobutane (R 365 mfc), heptafluoropropane, or else sulfur hexafluoride. Mixtures of at least two of these blowing agents can also be used. Foaming is preferably established at a pressure which is suitable and known to the person skilled in the art for foaming the mentioned ingredients.

Subsequent to the foaming curing typically takes place at room temperature, e.g. at 25° C. The foams comprising polyurethane contain a but minimal water-extractable fraction of not more than 2% by weight and preferably not more than 1% by weight; i.e., they contain only very small amounts of constituents which are not chemically bound.

The foams comprising polyurethane may be adhered to or laminated or coated with further materials, for example materials based on hydrogels, (semi)permeable films, foam films, coatings, hydrocolloids or other foams.

In a preferred embodiment the cosmetic application is selected from the group consisting of:
CA1. applying a cosmetic component to the skin or hair via the foam;
CA2. retracting a cosmetic component from the skin or hair via the foam; or
CA3. a combination of CA1. and CA2.

Preferably, the foam utilized for applying a cosmetic component in CA1. comprises at least one active ingredient. As active ingredient any ingredient can be selected which is able to be retained by the foam at least partly. Preferably, the active ingredient is selected of the group consisting of water, oil, a surfactant, a perfume, a sun blocker, a sun filter, a dye, a pigment, a disinfectant, a film former or mixtures of at least two thereof. The cosmetic component preferably is part of a cosmetic composition.

Within the context of the present invention, the cosmetic composition can advantageously be present in the following forms: cream, lotion, milk, gel, oil, balm, aqueous solution, aqueous dispersion, alcoholic solution or combinations of at least two thereof.

The cosmetic composition preferably comprises 0.1 to 20% by weight of a polyurethane as described in WO 2009/118107 on pages 5 to 17 and in particular 0.5 to 10% by weight, based on the total weight of the cosmetic composition.

Within the context of the present invention, the cosmetic compositions are differentiated in particular according to their consistency: cream (viscous), lotion and milk (flowable), gels (semisolid), oils, and also balm, aqueous solutions and aqueous dispersions, alcoholic solutions (liquid). Depending on their formulation, the cosmetic compositions can be used, for example, as face cream, day or night cream, body lotion etc. It is in some instances possible that the cosmetic compositions are used as pharmaceutically active product, or comprise pharmaceutically active ingredients.

The cosmetic compositions may be present, for example, in the form of oil-in-water, silicone-in-water, water-in-oil, water-in-silicone, oil-in-water-in-oil, water-in-oil-in-water emulsion.

The cosmetic compositions can comprise one or more emulsifiers or surface-active agents.

Thus, in particular oil-in-water emulsions (O/W) according to the invention comprise preferably at least one emulsifier with an HLB value of >7 and, if appropriate, a coemulsifier.

O/W emulsifiers can advantageously be selected from the group of nonionic, anionic, cationic or amphoteric emulsifiers.

The nonionic emulsifiers include:
a) partial fatty acid esters and fatty acid esters of polyhydric alcohols and ethoxylated derivatives thereof
b) ethoxylated fatty alcohols and fatty acids
c) ethoxylated fatty amines, fatty acid amides, fatty acid alkanolamides
d) alkylphenol polyglycol ethers (e.g. Triton® X)
e) ethoxylated fatty alcohol ethers.

Particularly advantageous nonionic O/W emulsifiers are ethoxylated fatty alcohols or fatty acids, preferably PEG-100 stearate, PEG-40 stearate, PEG-50 stearate, ceteareth-20, ceteth-20, steareth-20, ceteareth-12, ceteth-12, steareth-12, esters of mono-, oligo- or polysaccharides with fatty acids, preferably cetearyl glucoside, methylglucose distearate, glyceryl monostearates (self-emulsifying), sorbitan esters, such as, for example, sorbitan stearates (Tween® 20 and Tween® 60 from Uniqema), sorbitan palmitates (Span® 40, Uniqema), glyceryl stearyl citrates, sucrose esters, such as, for example, sucrose stearates, PEG-20 methyl glucose sesquistearate), dicarboxylic acid esters of fatty alcohol (dimyristyl tartrate).

Advantageous anionic emulsifiers are soaps (e.g. sodium or triethanolamine salts of stearic acid or palmitic acid), esters of citric acid, such as glyceryl stearate citrate, fatty alcohol sulphates, and also mono-, di- and trialkyl phosphoric acid esters and ethoxylates thereof.

The cationic emulsifiers include quaternary ammonium compounds with a long-chain aliphatic radical, e.g. distearyl dimonium chloride.

The amphoteric emulsifiers preferably include:
alkylaminoalkane carboxylic acids
betaines, sulphobetaines
imidazoline derivatives.

Furthermore, there are naturally occurring emulsifiers, which include beeswax, wool wax, lecithin and sterols.

Suitable coemulsifiers for the O/W emulsions according to the invention which can be used are fatty alcohols having 8 to 30 carbon atoms, monoglycerol esters of saturated or unsaturated, branched or unbranched alkanecarboxylic acids with a chain length of from 8 to 24 carbon atoms, in particular 12 to 18 carbon atoms, propylene glycol esters of saturated or unsaturated, branched or unbranched alkanecarboxylic acids with a chain length of from 8 to 24 carbon atoms, in particular 12 to 18 carbon atoms, and also sorbitan esters of saturated or unsaturated, branched or unbranched alkanecarboxylic acids with a chain length of from 8 to 24 carbon atoms, in particular 12 to 18 carbon atoms.

Particularly advantageous coemulsifiers are glyceryl monostearate, glyceryl monooleate, diglyceryl monostearate, sorbitan monoisostearate, sucrose distearate, cetyl alcohol, stearyl alcohol, behenyl alcohol, isobehenyl alcohol and polyethylene glycol(2) stearyl ether (steareth-2).

Furthermore, it may be advantageous to use further emulsifiers. Thus, for example, the water resistance of the preparations of the cosmetic composition can be increased. Suitable emulsifiers are, for example, alkylmethicone copolyols and alkyldimethicone copolyols, in particular cetyldimethicone copolyol, laurylmethicone copolyol, W/O emulsifiers, such as sorbitan stearate, glyceryl stearate, glycerol stearate, sorbitan oleate, lecithin, glyceryl isostearate, polyglyceryl-3 oleate, polyglyceryl-3 diisostearate, PEG-7-hydrogenated castor oil, polyglyceryl-4 isostearate, acrylate/C₁₀₋₃₀-alkyl acrylate crosspolymer, sorbitan isostearate, poloxamer 101, polyglyceryl-2 dipolyhydroxystearate, polyglyceryl-3 diisostearate, polyglyceryl-4 dipolyhydroxystearate, PEG-30 dipolyhydroxystearate, diisostearoyl polyglyceryl-3 diisostearate, glycol distearate and polyglyceryl-3 dipolyhydroxystearate or mixtures of at least two thereof.

The cosmetic composition, such as, in particular, the O/W compositions, can advantageously comprise thickeners of the water phase. Advantageous thickeners are:
Crosslinked or uncrosslinked acrylic acid or methacrylic acid homopolymers or copolymers. These include crosslinked homopolymers of methacrylic acid or acrylic acid, copolymers of acrylic acid and/or methacrylic acid and monomers which are derived from other acrylic or vinyl monomers, such as C10-30 alkyl acrylates, C10-30-alkyl methacrylates and vinyl acetate and vinylpyrrolidones.
Thickening polymers of natural origin, for example based on cellulose, guar gum, xanthan, scleroglucan, gellan gum, rhamsan and karaya gum, alginates, maltodextrin, starch and its derivatives, carob seed flour, hyaluronic acid, carrageenan.
Nonionic, anionic, cationic or amphoteric associative polymers, e.g. based on polyethylene glycols and their derivatives, or polyurethanes.
Crosslinked or uncrosslinked homopolymers or copolymers based on acrylamide or methacrylamide, such as homopolymers of 2-acrylamido-2-methylpropanesulphonic acid, copolymers of acrylamide or methacrylamide and methacryloyloxyethyltrimethylammonium chloride or copolymers of acrylamide and 2-acrylamido-2-methylpropanesulphonic acid.

Particularly advantageous thickeners are thickening polymers of natural origin, crosslinked acrylic acid or methacrylic acid homopolymers or copolymers and crosslinked copolymers of 2-acrylamido-2-methylpropanesulphonic acid.

Very particularly advantageous thickeners are xanthan gum, such as the products supplied under the names Keltrol® and Kelza® by CP Kelco or the products from RHODIA with the name Rhodopol, and guar gum, such as the products available under the name Jaguar® HP105 from RHODIA.

Very particularly advantageous thickeners are crosslinked homopolymers of methacrylic acid or acrylic acid which are commercially available from Lubrizol under the names Carbopol® 940, Carbopol® 941, Carbopol® 980, Carbopol® 981, Carbopol® ETD 2001, Carbopol® EDT 2050, Carbopol® 2984, Carbopol® 5984 and Carbopol® Ultrez 10, from 3V under the names Synthalen® K, Synthalen® L and Synthalen® MS.

Very particularly advantageous thickeners are crosslinked polymers of acrylic acid or methacrylic acid and a C₁₀₋₃₀-alkyl acrylate or C₁₀₋₃₀-alkyl methacrylate and copolymers of acrylic acid or methacrylic acid and vinylpyrrolidone. Such copolymers are commercially available, for example, from Lubrizol under the names Carbopol® 1342, Carbopol® 1382, Pemulen® TR1 or Pemulen® TR2 and from ISP under the names Ultrathix P-100 (INCI: Acrylic Acid/VP Crosspolymer).

Very particular advantageous thickeners are crosslinked copolymers of 2-acrylamido-2-methylpropanesulphonic acid. Such copolymers are available, for example, from Clariant under the names Aristoflex® AVC (INCI: Ammonium Acryloyldimethyltaurate/VP Copolymer).

These thickeners are generally present in the cosmetic composition in a concentration of from about 0% to 2% by weight, preferably 0% to 1% by weight, based on the total weight of the cosmetic composition.

Further cosmetic compositions may be water-in-oil or water-in-silicone emulsions. Preference is given to water-in-oil (W/O) or water-in-silicone emulsions (W/Si) which comprise one or more silicone emulsifiers (W/S) with an HLB value of 8 or one or more W/O emulsifiers with an HLB value of <7 and optionally one or more O/W emulsifiers with an HLB value of >10.

The silicone emulsifiers can advantageously be selected from the group comprising alkyldimethicone copolyols, such as, for example, cetyl PEG/PPG 10/1 dimethicone copolyol (ABIL® EM 90 from Goldschmidt AG) or lauryl PEG/PPG-18/18 dimethicones (Dow Corning 5200 from Dow Corning Ltd.) and dimethicone copolyols, such as, for example, PEG-10 dimethicones (KF-6017 from Shin Etsu), PEG/PPG-18/18 dimethicones (Dow Corning 5225C from Dow Corning Ltd.) or PEG/PPG-19/19 dimethicones (Dow Corning BY-11 030 from Dow Corning Ltd.) or trimethylsilylamodimethicones or mixtures of at least two thereof.

The W/O emulsifiers with an HLB value of <7 can advantageously be selected from the following group: fatty alcohols having 8 to 30 carbon atoms, monoglycerol esters of saturated and/or unsaturated, branched and/or unbranched alkanecarboxylic acids of chain length of from 8 to 24, in particular 12-18 carbon atoms, diglycerol esters of saturated and/or unsaturated, branched and/or unbranched alkanecarboxylic acids of chain length from 8 to 24, in particular 12-18, carbon atoms, monoglycerol ethers of saturated and/or unsaturated, branched and/or unbranched alcohols of chain length of from 8 to 24, in particular 12-18, carbon atoms, diglycerol ethers of saturated and/or unsaturated, branched and/or unbranched alcohols of chain length from 8 to 24, in particular 12-18, carbon atoms, propylene glycol esters of saturated and/or unsaturated, branched and/or unbranched alkanecarboxylic acids of chain length from 8 to 24, in particular 12-18, carbon atoms, and also sorbitan esters of saturated and/or unsaturated, branched and/or unbranched alkanecarboxylic acids of chain length from 8 to 24, in particular 12-18, carbon atoms or mixtures of at least two thereof.

Particularly advantageous W/O emulsifiers are: glyceryl monostearate, glyceryl monoisostearate, glyceryl monomyristate, glyceryl monooleate, diglyceryl monostearate, diglyceryl monoisostearate, propylene glycol monostearate, propylene glycol monoisostearate, propylene glycol monocaprylate, propylene glycol monolaurate, sorbitan monoisostearate, sorbitan monolaurate, sorbitan monocaprylate, sorbitan monoisooleate, sucrose distearate, cetyl alcohol, stearyl alcohol, arachidyl alcohol, behenyl alcohol, isobehenyl alcohol, selachyl alcohol, chimyl alcohol, polyethylene glycol(2) stearyl ether (steareth-2), glyceryl monolaurate, glyceryl monocaprate and glyceryl monocaprylate or mixtures of at least two thereof.

Further possible W/O emulsifiers are selected from the group of the compounds polyglyceryl-2 dipolyhydroxystearate, PEG-30 dipolyhydroxystearate, cetyldimethicone copolyol and polyglyceryl-3 diisostearate or mixtures of at least two thereof.

The O/W emulsifiers with an HLB value of >10 can advantageously be selected from the group comprising lecithin, trilaureth-4 phosphate, polysorbate-20, polysorbate-60, PEG-22 dodecyl glycol copolymer, sucrose stearate and sucrose laurate or mixtures of at least two thereof.

An oil thickener can advantageously be used for stabilizing the W/O emulsion against sedimentation or flocculation of the water droplets.

Particularly advantageous oil thickeners are organomodified clays, such as organomodified bentonites (Bentone® 34 from Rheox), organomodified hectorites (Bentone® 27 and Bentone® 38 from Rheox) or organomodified montmorillonite, hydrophobic pyrogenic silica, where the silanol groups are substituted by trimethylsiloxy groups (AEROSIL® R812 from Degussa) or with dimethylsiloxy groups or polydimethylsiloxane (AEROSIL® R972, AEROSIL® R974 from Degussa, CAB-O-SIL® TS-610, “CAB-O-SIL® TS-720 from Cabot), magnesium or aluminium stearate, or styrene copolymers, such as, for example, styrene-butadiene-styrene, styrene-isopropene-styrene, styrene-ethylene/butene-styrene or styrene-ethylene/propene-styrene or mixtures of at least two thereof.

The thickener for the fatty phase can be present in an amount of from 0.1 to 5% by weight, or preferably 0.4 to 3% by weight, based on the total weight of the emulsion.

The aqueous phase can also comprise stabilizers. The stabilizer can be, for example, sodium chloride, magnesium chloride or magnesium sulphate or mixtures of at least two thereof.

Oils can be used in W/O, W/Si and O/W emulsions.

If present, the fatty phase of the composition according to the invention can comprise one non-volatile oil and/or volatile oils and waxes. The O/W composition comprises advantageously 0.01 to 45% by weight of oils, based on the total weight of the composition, and particularly advantageously 0.01 to 20% by weight of oils. The W/O or W/Si composition advantageously comprises at least 20% by weight of oils, based on the total weight of the composition.

The non-volatile oil is advantageously selected from the group of mineral, animal, vegetable or synthetic origin, polar or nonpolar oils and mixtures thereof.

The lipid phase of the cosmetic or dermatological emulsions according to the invention can advantageously be selected from the following group of substances:

mineral oils, mineral waxes, polar oils, such as triglycerides of capric acid or of caprylic acid, also natural oils, such as, for example, castor oil, fats, waxes and other natural and synthetic fatty bodies, preferably esters of fatty acids with alcohols of low carbon number, e.g. with isopropanol, propylene glycol or glycerol, or esters of fatty alcohols with alkanoic acids of low carbon number or with fatty acids; alkyl benzoates; silicone oils, such as dimethylpolysiloxanes, diethylpolysiloxanes, diphenylpolysiloxanes, or mixtures of at least two thereof.

The polar oils are advantageously selected from the group:

a) esters of saturated and/or unsaturated, branched and/or unbranched alkanecarboxylic acids of chain length from 3 to 30 carbon atoms and saturated and/or unsaturated, branched and/or unbranched alcohols of chain length from 3 to 30 carbon atoms,
b) esters of aromatic carboxylic acids and saturated and/or unsaturated, branched and/or unbranched alcohols of chain length from 3 to 30 carbon atoms.

Such ester oils can then advantageously be selected from the group:

isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, isotridecyl isononanoate, 2-ethylhexyl palmitate, 2-ethylhexyl laurate, 2-ethylhexyl isostearate, 2-hexyldecyl stearate, 2-octyldodecyl palmitate, 2-ethylhexyl cocoate, oleyl oleate, oleyl erucate, erucyl oleate, erucyl erucate, dicaprylyl carbonate (Cetiol® CC) and cocoglycerides (Myritol® 331), and also synthetic, semisynthetic and natural mixtures of such esters, e.g. jojoba oil.

c) alkyl benzoates C12-15-alkyl benzoate (Finsoly® TN from Finetex) or 2-phenylethyl benzoate (X-Tend® 226 from ISP)
d) lecithins and the fatty acid triglycerides, namely the triglycerol esters of saturated and/or unsaturated, branched and/or unbranched alkanecarboxylic acids of chain length from 8 to 24, in particular 12 to 18 carbon atoms. For example, the fatty acid triglycerides can be selected from the group of cocoglyceride, olive oil, sunflower oil, soybean oil, peanut oil, rapeseed oil, almond oil, palm oil, coconut oil, castor oil, wheat germ oil, grapeseed oil, safflower oil, evening primrose oil, macadamia nut oil, apricot kernel oil, avocado oil and the like.
e) of dialkyl ethers and dialkyl carbonates, e.g. dicaprylyl ether (Cetiol® OE from Cognis) and/or dicaprylyl carbonate (for example Cetiol® CC from Cognis) are advantageous
f) of saturated or unsaturated, branched or unbranched alcohols, such as, for example, octyldodecanol.

The non-volatile oil can likewise advantageously also be a nonpolar oil which is selected from the group of branched and unbranched hydrocarbons, in particular mineral oil, vaseline oil, paraffin oil, squalane and squalene, polyolefins, for example polydecenes, hydrogenated polyisobutenes, C13-16 isoparaffin and isohexadecane.

The nonpolar non-volatile oil can be selected among the non-volatile silicone oils.

Of the non-volatile silicone oils, the polydimethylsiloxanes (PDMS), which are optionally phenylated, such as phenyltrimethicone, or are optionally substituted with aliphatic and/or aromatic groups or with functional groups, for example hydroxyl groups, thiol groups and/or amino groups; polysiloxanes modified with fatty acids, fatty alcohols or polyoxyalkylenes and mixtures thereof can be given.

Particularly advantageous oils are 2-ethylhexyl isostearate, octyldodecanol, isotridecyl isononanoate, isoeicosane, 2-ethylhexyl cocoate, C12-15 alkyl benzoate, caprylic/capric triglyceride, dicaprylyl ether, mineral oil, dicaprylyl carbonate, cocoglycerides, butylene glycol dicaprylate/dicaprate, hydrogenated polyisobutenes, cetaryl isononanoates, isodecyl neopentanoates, squalane, C13-16 isoparaffin.

The cosmetic composition can also comprise a wax.

Within the context of the present specification, a wax is defined as a lipophilic fatty substance which is solid at room temperature (25° C.) and exhibits a reversible solid/liquid change in state at a melting temperature between 30° C. and 200° C. Above the melting point, the wax becomes low viscosity and miscible with oils.

The wax is advantageously selected from the groups of natural waxes, such as, for example, cotton wax, carnauba wax, candelilla wax, esparto wax, Japan wax, Montan wax, sugarcane wax, beeswax, wool wax, shellac, microwaxes, ceresine, ozokerite, ouricury wax, cork fibre wax, lignite waxes, berry wax, shea butter or synthetic waxes, such as paraffin waxes, polyethylene waxes, waxes produced by Fischer-Tropsch synthesis, hydrogenated oils, fatty acid esters and glycerides which are solid at 25° C., silicone waxes and derivatives (alkyl derivatives, alkoxy derivatives, and/or esters of polymethylsiloxane) or mixtures of at least two thereof. The waxes can be present in the form of stable dispersions of colloidal wax particles which can be prepared by known processes, for example as in “Microemulsions Theory and Practice”, L. M. Prince Ed., Academic Press (1977), pages 21-32.

Waxes may be present in the cosmetic composition in amounts of from 0 to 10% by weight, based on the total weight of the cosmetic composition, and preferably 0 to 5% by weight.

The cosmetic composition can also comprise a volatile oil which is selected from the group of volatile hydrocarbon oils, siliconized oils and fluorinated oils or mixtures of at least two thereof.

The volatile oil can be present in an amount of from 0 to 25% by weight, based on the total weight of the emulsion, preferably 0 to 20% by weight and even more preferably 0 to 15% by weight.

Within the context of the present specification, a volatile oil is an oil which, upon contact with the skin at room temperature and atmospheric pressure, evaporates in less than one hour. The volatile oil is liquid at room temperature and, at room temperature and atmospheric pressure, has a vapour pressure of from 0.13 to 40 000 Pa (10⁻³ to 300 mm Hg), preferably 1.3 to 13 000 Pa (0.01 to 100 mmHg) and particularly preferably 1.3 to 1300 Pa (0.01 to 10 mmHg) and a boiling point of from 150 to 260° C. and preferably 170 to 250° C.

A hydrocarbon oil is understood as meaning an oil which is formed essentially from carbon atoms and hydrogen atoms and optionally oxygen atoms or nitrogen atoms and contains no silicon atoms or fluorine atoms, where it may also consist of carbon atoms and hydrogen atoms; however, it can also contain ester groups, ether groups, amino groups or amide groups.

A siliconized oil is understood as meaning an oil which contains at least one silicon atom and in particular Si—O groups.

A fluorinated oil is to be understood as meaning an oil which contains at least one fluorine atom.

The volatile hydrocarbon oil according to the invention can be selected from the hydrocarbon oils with a flash point of from 40 to 102° C., preferably 40 to 55° C. and even more preferably 40 to 50° C.

For example, the volatile hydrocarbon oils are those with 8 to 16 carbon atoms and mixtures thereof, in particular branched C₈₋₁₆-alkanes, such as the isoalkanes (which are also referred to as isoparaffins) with 8 to 16 carbon atoms, isododecane, isodecane, isohexadecane and, for example, the oils which are supplied under the tradenames Isopars® or Permetyls®; and the branched C₈₋₁₆-esters, such as isohexyl neopentanoate or mixtures of at least two thereof.

The volatile hydrocarbon oils such as isododecane, isodecane and isohexadecane are particularly advantageous.

The volatile siliconized oil is preferably selected from the siliconized oils with a flash point of from 40 to 102° C., preferably a flash point above 55° C. and at most 95° C. and particularly preferably in the range from 65 to 95° C.

For example, the volatile siliconized oils are straight-chain or cyclic silicone oils having 2 to 7 silicon atoms, where these silicones optionally contain alkyl or alkoxy groups having 1 to 10 carbon atoms.

The volatile siliconized oils such as octamethylcyclotetrasiloxane, decamethylcyclopentasiloxane, dodecamethylcyclohexasiloxane, heptamethylhexyltrisiloxane, heptamethyloctyltrisiloxane, hexamethyldisiloxane, octamethyltrisiloxane, decamethyltetrasiloxane, dodecamethylpentasiloxane or mixtures of at least two thereof are particularly advantageous.

Preferably, the volatile fluorinated oil generally has no flash point.

For example, the volatile fluorinated oils are nonafluoroethoxybutane, nonafluoromethoxybutane, decafluoropentane, tetradecafluorohexane, dodecafluoropentane and mixtures thereof.

The cosmetic acceptable medium of the cosmetic composition preferably comprises water and optionally a cosmetically suitable water-miscible organic solvent.

The water used in the cosmetic composition may be a blossom water, pure demineralized water, mineral water, thermal water and/or seawater.

In the case of an O/W composition, the water fraction can be in the range from 40 to 95% by weight, preferably in the range from 50 to 90% by weight, very particularly in the range from 60 to 80% by weight, based on the total weight of the composition. In the case of a W/O composition, the water fraction is in the range from 0 to 60% by weight, preferably in the range from 10 to 50% by weight, very preferably in the range from 30 to 50% by weight, based on the total weight of the cosmetic composition.

The preferred solvents are, for example, the aliphatic alcohols with C1-4 carbon atoms, such as ethanol and isopropanol; polyol and derivatives thereof, such as propylene glycol, dipropylene glycol, butylene-1,3 glycol, polypropylene glycol, glycol ethers such as alkyl (C1-4) ethers of mono-, di- or tripropylene glycol or mono-, di- or triethylene glycol, and mixtures thereof.

The quantitative fraction of the solvent or solvents in the composition preferably are in the range of from 0 to 25% by weight and preferably 0 to 15% by weight, based on the total weight of the cosmetic composition.

The cosmetic composition preferably additionally comprises additives which are customary in cosmetics, such as antioxidants, photoprotective agents and/or other auxiliaries and additives, such as, for example, emulsifiers, interface-active substances, antifoams, thickeners, surfactants, active ingredients, humectants, filler, UV filters, film formers, solvents, coalescing agents, aroma substances, odour absorbers, perfumes, gel formers and/or other polymer dispersions, such as, for example, dispersions based on polyacrylates, pigments, dyes, flow agents and/or thixotropic agents, suppleness agents, softeners, preservatives or mixtures of at least two thereof. The amounts of the various additives are known to the person skilled in the art for the range to be used and are, for example, in the range from 0 to 25% by weight, based on the total weight of the cosmetic composition.

The cosmetic composition preferably also comprises sensory additives. Sensory additives are to be understood as meaning colourless or white, mineral or synthetic, lamellar, spherical or elongated inert particles or a nonparticulate sensory additive which, for example, further improve the sensory properties of the formulations and, for example, leave behind a velvety or silky skin feel.

The sensory additives are preferably present in the cosmetic composition in an amount of from 0 to 10% by weight, based on the total weight of the cosmetic composition, and preferably from 0 to 7%.

Advantageous particulate sensory additives within the context of the present invention are talc, mica, silicon dioxide, kaolin, starch and derivatives thereof (for example tapioca starch, distarch phosphate, aluminium and sodium starch octenyl succinate and the like), pyrogenic silica, pigments which have neither primarily a UV-filter effect nor colouring effect (such as e.g. boron nitride etc.), boron nitride, calcium carbonate, dicalcium phosphate, magnesium carbonate, magnesium hydrogencarbonate, hydroxyapatites, microcrystalline cellulose, powders of synthetic polymers, such as polyamides (for example the polymers available under the trade name “Nylon®”), polyethylene, poly-β-alanine, polytetrafluoroethylene (“Teflon®”), polyacrylate, polyurethane, lauroyl-lysine, silicone resin (for example the polymers available under the trade name “Tospearl®” from Kobo Products Inc.), hollow particles of polyvinylidene/acrylonitriles (Expancel® from Akzo Nobel) or hollow particles of silicon oxide (Silica Beads® from MAPRECOS) or mixtures of at least two thereof.

Advantageous nonparticulate sensory additives can be selected from the group of dimethiconols (e.g. Dow Corning 1503 Fluid from Dow Corning Ltd.), silicone copolymers (e.g. divinyldimethicone/dimethicone copolymer, Dow Corning HMW 2220 from Dow Corning Ltd.) and silicone elasters (e.g. dimethicone crosspolymer, Dow Corning 9040 Silicone Elastomer Blend from Dow Corning Ltd.) or mixtures of at least two thereof.

The cosmetic composition preferably also comprises sunscreen filters, where the total amount of the sunscreen filter is 0% to 30% by weight, 0% to 20% by weight, particularly advantageously 0% to 10% by weight, based on the total weight of the cosmetic composition. The sunscreen filters (or UV filters) can in particular be selected from the organic filters, the physical filters and mixtures thereof.

The cosmetic composition preferably comprises UV-A filters, UV-B filters or broadband filters or mixtures of at least two thereof. The UV filters used can be oil-soluble or water-soluble. The list of specified UV filters below is of course not limiting.

Examples of the UV-B filters are:
(1) salicylic acid derivatives, particularly homomenthyl salicylate, octyl salicylate and 4-isopropylbenzyl salicylate;
(2) cinnamic acid derivatives, in particular 2-ethylhexyl p-methoxycinnamate, which is available from Givaudan under the name Parsol MCX® and isopentyl 4-methoxycinnamate;
(3) liquid β,β′-diphenylacrylate derivatives, in particular 2-ethylhexyl α,β′-diphenylacrylate or octocrylene, which is available from BASF under the name UVINUL N539®;
(4) p-aminobenzoic acid derivatives, in particular 2-ethylhexyl 4-(dimethylamino)benzoate, amyl 4-(dimethylamino)benzoate;
(5) 3-benzylidenecamphor derivatives, in particular 3-(4-methylbenzylidene)camphor which is commercially available from Merck under the name EUSOLEX 6300®, 3-benzylidenecamphor, benzylidenecamphor sulphonic acid and polyacrylamidomethylbenzylidenecamphor;
(6) 2-phenylbenzimidazole-5-sulphonic acid, which is available under the name EUSOLEX 232® from Merck;
(7) 1,3,5-triazine derivatives, in particular: -2,4,6-tris[p-(2′-ethylhexyl-1′-oxycarbonyl)anilino]-1,3,5-triazine, which is supplied by BASF under the name UVINUL T150®, and -dioctylbutamidotriazone, which is supplied by Sigma 3V under the name UVASORB HEB®;
(8) esters of benzalmalonic acid, in particular di(2-ethylhexyl) 4-methoxybenzalmalonate and 3-(4-(2,2-bisethoxycarbonylvinyl)-phenoxy)propenyl)methoxysiloxane/dimethylsiloxane copolymer, which is available from Roche Vitamines under the name Parsol® SLX; and
(9) mixtures of at least two of (1) to (8).

Examples of UV-A filters are:
(1) dibenzoylmethane derivatives, particularly 4-(t-butyl)-4′-methoxydibenzoylmethane, which is supplied by Givaudan under the name PARSOL 1789® and 1-phenyl-3-(4′-isopropylphenyl)propane-1,3-dione;
(2) benzene-1,4-[di(3-methylidenecamphor-10-sulphonic acid)], optionally completely or partially neutralized, commercially available under the name MEXORYL SX® from Chimex.
(3) hexyl 2-(4′-diethylamino-2′-hydroxybenzoyl)benzoate (also aminobenzophenone);
(4) silane derivatives or polyorganosiloxanes with benzophenone groups;
(5) anthranilates, particularly menthyl anthranilate, which is supplied by Symrise under the name NEO HELIOPAN MA®;
(6) compounds which contain at least two benzoazolyl groups or at least one benzodiazolyl group per molecule, in particular 1,4-bis-benzimidazolylphenylene-3,3′,5,5′-tetrasulphonic acid and its salts, which are commercially available from Symrise;
(7) silicon derivatives of benzimidazolylbenzazoles, which are N-substituted, or of benzofuranylbenzazoles, in particular: -2-[1-[3-[1,3,3,3-tetramethyl-1-[(trimethylsilyl)oxy]disiloxanyl]propyl]-1H-benzimidazol-2-yl]benzoxazole; -2-[1-[3-[1,3,3,3-tetramethyl-1-[(trimethylsilyl)oxy]disiloxanyl]propyl]-1H-benzimidazol-2-yl]benzothiazole; -2-[1-(3-trimethylsilanylpropyl)-1H-benzimidazol-2-yl]benzoxazole; 6-methoxy-1,1′-bis(3-trimethylsilanylpropyl)-1H,1′H-[2,2′]dibenzimidazolylbenzoxazole; -2-[1-(3-trimethylsilanylpropyl)-1H-benzimidazol-2-yl]benzothiazole; which are described in the patent application EP-A-1 028 120;
(8) triazine derivatives, in particular 2,4-bis[5-1(dimethylpropyl)benzoxazol-2-yl-(4-phenyl)imino]-6-(2-ethylhexyl)imino-1,3,5-triazine, which is supplied by 3V under the name Uvasorb® K2A; and
(9) mixtures of at least two of (1) to (8).

Examples of broadband filters are:
(1) benzophenone derivatives, for example -2,4-dihydroxybenzophenone (benzophenone-1); -2,2′,4,4′-tetrahydroxybenzophenone (benzophenone-2); -2-hydroxy-4-methoxybenzophenone (benzophenone-3), available from BASF under the name UNIVNUL M40®; -2-hydroxy-4-methoxybenzophenone-5-sulphonic acid (benzophenone-4), and its sulphonate form (benzophenone-5), commercially available from BASF under the name UVINUL MS40®; -2,2′-dihydroxy-4,4′-dimethoxybenzophenone (benzophenone-6-); -5-chloro-2-hydroxybenzophenone (benzophenone-7-); -2,2′-dihydroxy-4-methoxybenzophenone (benzophenone-8); -the disodium salt of 2,2′-dihydroxy-4,4′-dimethoxybenzophenone-5,5′-disulphonic acid (benzophenone-9-); -2-hydroxy-4-methoxy-4′-methylbenzophenone (benzophenone-10);
   -benzophenone-11; -2-hydroxy-4-(octyloxy)benzophenone (benzophenone-12).
(2) triazine derivatives, in particular 2,4-bis{[4-2-ethylhexyloxy)-2-hydroxy]-phenyl}-6-(4-methoxyphenyl)-1,3,5-triazine, which is supplied by Ciba Geigy under the name TINOSORB S®, and 2,2′-methylenebis[6-(2H-benzotriazol-2-yl)4-(1,1,3,3-tetramethylbutyl)phenol], which is available from Ciba Geigy under the name TINOSORB M®; and
(3) 2-(1H-benzotriazol-2-yl)-4-methyl-6-[2-methyl-3-[1,3,3,3-tetramethyl-1-[(trimethylsilyl)oxy]disiloxanyl]propyl]phenol with the INCI name Drometrizole Trisiloxane.
(4) mixtures of at least two of (1) to (3)

It is also possible to use a mixture of two or more filters and a mixture of UV-B filters, UV-A filters and broadband filters, and also mixtures with physical filters.

Of the physical filters, the sulphates of barium, oxides of titanium (titanium dioxide, amorphous or crystalline in the form of rutile and/or anatase), of zinc, of iron, of zirconium, of cerium, silicon, manganese or mixtures thereof may be given. The metal oxides can be present in particle form with a size in the micrometre range or nanometre range (nanopigments). The average particle sizes for the nanopigments are, for example, 5 to 100 nm.

The cosmetic composition preferably comprises humectants or moisturizers.

Particularly advantageous humectants or moisturizers within the context of the present invention are, for example, glycerol, polyglycerol, sorbitol, dimethyl isosorbide, lactic acid and/or lactates, in particular sodium lactate, butylene glycol, propylene glycol, biosaccaride gum-1, glycine soya, hydroxyethylurea, ethylhexyloxyglycerol, pyrrolidonecarboxylic acid and urea. In addition, it is especially advantageous to use polymeric “moisturizers” from the group of water-soluble and/or water-swellable and/or water-gellable polysaccharides. For example, hyaluronic acid, chitosan and/or a fucose-rich polysaccharide, which is available under the name Fucogel™ 1000 from SOLABIA S.A., are especially advantageous.

Within the context of the present invention, water-soluble antioxidants can be used particularly advantageously, such as, for example, vitamins, e.g. ascorbic acid and derivatives thereof. Vitamin E and derivatives thereof, and also vitamin A and derivatives thereof are very particularly advantageous.

Further advantageous active ingredients in the composition according to the invention are α-hydroxy acid, such as glycolic acid, lactic acid, malic acid, tartaric acid, citric acid and mandelic acid, β-hydroxy acid, such as salicylic acid, and acylated derivatives thereof, 2-hydroxyalkanoic acid and its derivatives; natural active ingredients and/or derivatives thereof, such as, for example, alpha-lipoic acid, folic acid, phytoene, D-biotin, coenzyme Q10, alpha-glucosylrutin, carnitine, carnosine, natural and/or synthetic isoflavonoids, creatin, creatinine, taurine and/or [beta]-alanine and also 8-hexadecene-1,16-dicarboxylic acid (dioic acid, CAS number 20701-68-2; provisional INCI name Octadecenedioic acid) and/or Licochalcon A and the plant extracts.

Preferably, the disinfectant is selected from the group consisting of a bactericide, a fungicide or a mixture thereof. Examples of disinfectants are an alcohol, like ethanol, 1-propanole or 2-propanol or mixtures of at least two thereof and ethylene oxide or chloramine T or a mixture of at least two thereof.

In a preferred embodiment the foam provides at least one, preferably at least two or preferably all of the following properties:
F1) A density in a range of from 0.01 to 0.5 g/cm³; or preferably in a range of from 0.05 to 0.45 g/cm³; or in a range of from 0.1 to 0.4 g/cm³;
F2) An tensile strength in a range of from 20 to 100 kPa, or preferably in a range of from 25 to 90 kPa, or in a range of from 30 to 80 kPa; (determined according to DIN 53504);
F3) An elongation at break in a range of from 20 to 100%, or preferably in a range of from 25 to 90%; (determined according to DIN 53455);
F4) A rebound elasticity of greater than 50%, or preferably of greater than 60%, or preferably of greater than 70% (determined according to DIN EN ISO 3386-1);
F5) A water retention capacity in a range of from ≥5 g/g, or preferably ≥10 g/g, or preferably ≥15 g/g, or preferably in a range of from 5 to 20 g/g;
F6) A maximal water absorption rate in a range of from ≥50% to 2500%, or preferably in a range of from 100 to 2000%, or preferably in a range of from 200 to 1500%, according to DIN EN 13726-1 with a piece of foam with a dimension of 5*5 cm;
F7) A surface roughness in a range of from 200 to 2000 nm, or preferably in a range of from 300 to 1800 nm, or preferably in a range of from 500 to 1500 nm.

The retention capacity (Centrifuge Retention Capacity, CRC) mentioned in F5) is determined according to a test recommended by the EDANA (European Disposables and Nonwovens Association, Avenue Eugene Plasky 157, 1030 Brüssel, Belgien) with the Test No. 441.2-02 “Centrifuge Retention Capacity”.

The polyurethane foams obtained by the process according to the present invention further have pleasant haptics and a porous, at least partly open-celled structure comprising intercommunicating cells. The apparent density of these polyurethane foams is typically in the range from 0.01 to 0.5 g/cm³ (determination according to DIN 53420). The polyurethane foams further have good mechanical strength and high elasticity. Typically, tensile strength is greater than 30 kPa and elongation at break is greater than 20% (determination according to DIN 53504, DIN 53455).

In a preferred embodiment the foam further comprises
I) a superabsorber,
II) a thickener,
III) a diluent,
IV) a filler,
V) a dye.

The superabsorber can be any chemical that increases the absorption capability of the foam. Preferably, the superabsorber is selected from the group consisting of a Polyacrylate and a caboxymethylcellulose or a mixture thereof. The thickener is preferably selected from the group consisting of those described above in the context of the cosmetic composition. The diluent is preferably selected from the group consisting of water, organic solvent like alcohols, e.g. ethanol, 1-propanol, 2,propanol or mixtures of at least two thereof. The filler is preferably selected from the group consisting of a calcite, a talcum or a mixture thereof. The dye is preferably selected from the group consisting of any organic or inorganic material that creates a color different than black or white.

A further aspect of the invention relates to a process for applying a cosmetic component to a skin or hair of a human or animal, comprising at least the following steps:
i. Providing a foam comprising a polyurethane;
ii. Contacting the foam with a cosmetic component in a way that at least a part of the cosmetic component is in contact with the foam forming an active part of the foam;
iii. Contacting the skin or hair of a human or an animal with the active part of the foam in a way that the cosmetic component covers at least a part of the contacted skin or hair;

The providing of the foam in step i. can be established in any manner the person skilled in the art would select for this reason. Preferably, the foam is provided in a sterile manner. Examples to provide the foam in a sterile manner are packaging of the foam in a water-proof pocket, a non-water-proof pocket. The material of the water-proof pocket is preferably selected from the group consisting of polyethylene, polypropylene, polymethylmethacrylate, polycarbonate, polyurethane or a mixture of at least two thereof. The material of the non-water-proof pocket is preferably selected from the group consisting of cellulose, poly lactic acid or a mixture thereof. Especially, if the foam is impregnated by a fluid an water-proof packaging is favorable.

The contacting of the foam with the cosmetic component in step ii., for example in form of the cosmetic composition, could be established by the user or any other person. Preferably, the pressure during step ii. of the foam on the cosmetic component is in a range of from 0.1 to 2 MPa, or preferably in a range of from 0.2 to 1 MPa, or preferably in a range of from 0.3 to 0.5 MPa. By applying a certain amount of pressure to the foam, at least a part of the cosmetic component is forced to suck into the foam and/or sticks to the surface of the foam. The applying of pressure could be established by any means to apply pressure to a foam. Examples of application machines are rolls, pressurized chambers, suction filters or any tool known in the prior art for applying fluids or powders to foams.

The contacting of the skin or hair of the human or animal in step iii. with the active part of the foam can be established by any manner the person skilled in the art would select for this step. Preferably, the pressure during step iii. of the foam on the skin or hair is in a range of from 0.1 to 0.5 MPa, or preferably in a range of from 0.15 to 4.5 MPa, or preferably in a range of from 0.2 to 0.3 MPa. By applying a certain amount of pressure to the skin or hair via the foam, at least a part of the cosmetic component that is in or on the foam is released to the skin or hair. Preferably, at least 10 wt.-%, or preferably at least 20 wt.-%, or preferably at least 30 wt.-% of the cosmetic component in or on the foam is released to the skin or hair of the user.

The foam can have any shape, thickness, color or size the person skilled in the art would select for the process. Preferably, the foam has a shape selected from the group consisting of round, oval, polygonal, square or any combination of at least two thereof. Preferably, the foam has a thickness in a range of from 0.05 to 10 mm, or preferably in a range of from 0.1 to 5 mm, or in a range of from 0.2 to 3 mm. Preferably, the foam has a size, meaning a surface in the range of from 1 cm² to 10 m², or preferably in a range of from 2 cm² to 5 m², or preferably in a range of from 3 cm² to 2 m². The color may be any the person skilled in the art would select for the foam. Preferably, the foam does not comprise any pigments or dyes and therefor has a white color. Alternatively, pigments may be added to the foam which provide a skin or hair like color or which provides the color of the cosmetic component that should be applied to the skin or hair.

Depending on the particular cosmetic application a different shape of the foam might be advantages. For example, for the application of a cosmetic component on the skin in the face of a user, a pad like piece of foam would be beneficial which normally has a surface in a range of from 1 to 50 cm², or preferably in a range of from 2 to 40 cm², or preferably in a range of from 3 to 30 cm². However, if the whole face should be treated at once, a much broader surface than of a pad. Preferably, the surface of the foam is then in a range of from 50 to 1000 cm², or preferably in a range of from 60 to 500 cm², or preferably in a range of from 100 to 300 cm². For applications of the cosmetic composition provided via the foam, preferably the foam is brought into contact with the skin by means selected from the group consisting of laying the foam on the skin, pressing the foam onto the skin by pressing a hand on the foam, pressing the foam onto the skin by pressing a weight onto the skin.

Also the thickness of the foam in the different application fields can vary. In case of a pad like foam to just treat a part of the skin of the face the foam preferably provides a thickness in a range of from 0.1 to 5 mm, or preferably in a range of from 0.2 to 3 mm, or preferably in a range of from 0.5 to 2 mm.

Preferably, the cosmetic application is selected from the group consisting of painting one's face, putting on lipstick, putting on eye make-up, putting on a face mask, cooling skin, relaxing skin, cleaning skin and/or hair, coloring hair, conditioning hair or combinations of at least two thereof.

A further aspect of the invention relates to a process for cleaning a part of a skin or hair of a human or an animal, comprising the steps:
I. Providing a foam comprising a polyurethane;
II. Contacting at least the part of the skin or hair of a human or an animal by the foam which should be cleaned;
III. Removing the foam from the skin or hair of the human or the animal

The foam can have a shape, thickness, color and size as described before. The providing of the foam in step I. can be established in any manner the person skilled in the art would select for this reason. Preferably, the foam is provided in a sterile manner. Examples to provide the foam in a sterile manner are packaging of the foam in a water-proof pocket, a non-water-proof pocket. The material of the water-proof pocket is preferably selected from the group consisting of polyethylene, polypropylene, polymethylmethacrylate, polycarbonate, polyurethane or a mixture of at least two thereof. The material of the non-water-proof pocket is preferably selected from the group consisting of cellulose, poly lactic acid or a mixture thereof. Especially, if the foam is impregnated by a fluid a water-proof packaging is favorable for storing and transporting the foam.

A further aspect of the invention relates to an applicator, comprising at least the following components:
(1) a foam, comprising a polyurethane;
(2) a cosmetic component on a surface of the foam or inside the foam.

The applicator preferably has the size, geometry, ingredients as described for the foam comprising a polyurethane above. Preferably, the foam (1) is produced in the same manner as described for the foam above. The foam (1) preferably comprises the cosmetic component (2) on at least one surface of the foam or inside the foam or both. It depends on the consistency of the cosmetic component and on the reason and way of application of the cosmetic component whether the cosmetic component is provided on the surface of the foam or is inside the foam. In case of the application of e.g. a color fluid for coloring of hair, the color fluid is preferably inside of the foam. In case a powder should be applied to a skin of a user via the applicator, the powder is essentially provided on the surface of the foam. There might be applications where the cosmetic component is preferably on the surface and in the inside of the foam. As an example, the establishing of a hairstyle could be provided by utilising the applicator. The applicator preferably is therefore provided in lamellar foam pieces which are impregnated by color fluid, as shampoo, a conditioner or any other fluid that should be applied to hair to achieve the hairstyle. Especially, if only strands of hair should be treated, for example by color, shampoo, conditioner or other fluids, the lamellar foam pieces might be shaped in form of the desired strands. In a preferred method to use the applicator to apply a fluid to hair the following steps are provided:
1. selecting at least one strand of hair,
2. a piece of foam which is impregnated by the cosmetic component is located below the selected strand of step 1.;
3. optionally, pressing of the piece of foam around the strand with a pressure which is high enough to squeeze out the cosmetic component on the hair.

Alternatively, the foam is not impregnated by the cosmetic component but helps to apply the cosmetic component to be applied in an efficient way. In this alternative method the following steps are preferably provided:
1. selecting of a strand of hair;
2. a piece of foam is located below the selected strand of step 1.;
3. the desired cosmetic component is applied on the strand of hair, whereby the foam hinders the cosmetic component to come into contact with other part of hair or the skin of the user;
4. optionally pressing the piece of foam around the strand with a pressure which is high enough to distribute the cosmetic component on the hair of the selected hair strand of step 1.

By applying one of the described methods the cosmetic components necessary to achieve a hairstyle selected from the group consisting of a permanent wave, a coloring, a nourishing, a shaping or a combination of at least two thereof.

In a preferred embodiment of the applicator the cosmetic component is selected from the group consisting of a surfactant, a cream, a powder, a fluid, a pharmaceutical, an oil, a shampoo, a conditioner, a color, a hair color or a combination of at least two thereof. Examples of cosmetic components have already been described above. These may all be applied by the applicator according to the invention.

A further aspect of the invention relates to a layered structure comprising at least the following layers:
L1st) A first foam comprising a polyurethane;
L2nd) An interlayer, providing a first surface and a second surface, wherein the second surface is essentially oriented in parallel to the first surface;
L3rd) A second foam comprising a polyurethane.

The interlayer can be any material that might be suitable for the formation of a layered structure according to the invention. Preferably, the interlayer is selected from the group consisting of a film, a foam, a coating or a combination of at least two thereof. Preferably, the interlayer provides an ability to stiffen the layered structure.

Preferably, the first foam L1st) and the second foam L3rd) are produced in the same manner and have the same ingredients, the same sizes, shapes, and properties as described for the use of a foam comprising a polyurethane according to the invention. Preferably, the first and/or the second foam is directly applied to the interlayer L2nd). The production of the layered structure preferably comprises a first step where the first foam L1st) is applied onto the interlayer L2nd) which preferably is provided in a continuous manner, e.g. in a roll to roll process. Preferably, in a first step the interlayer is provided on the roll and the first foam L1st) is applied to a first surface of the interlayer L2nd) to build a precursor of the layered structure Preferably, the precursor is also provided on a roll. Preferably, the precursor is provided in a second step as roll and the second foam L3rd) is applied to the second surface of the interlayer L2nd) to build the interlayered structure.

Preferably, the interlayer L2nd) is a foil. Preferably, the foil provides a thickness in the range of from 0.01 to 5 mm, or preferably in the range of from 0.05 to 4 mm, or preferably in the range of from 0.1 to 3 mm. Preferably, the foil comprises a material selected from the group consisting of polycarbonate, polymethylmethacrylate, polyamine, polyamide, polyurethane, polysiloxane, polyacrylate or a mixture or a combination of at least two thereof. Preferably, the foil comprises more than one layer. Each layer may comprise different materials and thicknesses. Preferably, the size of the surface of the foil is the same as the size of the surface of the foam. During production of the layered structure, the foil may have a larger surface than the foam. After the application of the foam onto the surface of the foil the dimension of the surface of the foil is decreased in manner that it is similar to the surface of the foam.

To achieve the layered structure according to the invention the foams comprising polyurethane may be adhered to or laminated or coated with further materials, for example materials based on hydrogels, (semi)permeable films, foam films, coatings, hydrocolloids or other foams.

In a preferred embodiment of the layered structure the interlayer provides at least one of the following properties:
EF1 The interlayer comprises a polyurethane foil,
EF2 The interlayer comprises a non-woven,
EF3 The interlayer comprises a paper,
EF4 The interlayer has a thickness in the range of from 10 μm to 5 mm.

In a preferred embodiment of the layered structure the first foam and/or the second foam provides at least one of the following properties:
F1) A density in a range of from 0.01 to 0.5 g/cm³; or preferably in a range of from 0.05 to 0.45 g/cm³; or in a range of from 0.1 to 0.4 g/cm³;
F2) An tensile strength in a range of from 20 to 100 kPa, or preferably in a range of from 25 to 90 kPa, or in a range of from 30 to 80 kPa; (determined according to DIN 53504);
F3) An elongation at break in a range of from 20 to 100%, or preferably in a range of from 25 to 90%; (determined according to DIN 53455);
F4) A rebound elasticity of greater than 50%, or preferably of greater than 60%, or preferably of greater than 70% (determined according to DIN EN ISO 3386-1);
F5) A water retention capacity in a range of from ≥5 g/g, or preferably ≥10 g/g, or preferably ≥15 g/g, or preferably in a range of from 5 to 20 g/g;
F6) A water absorption rate in a range of from ≥50% to 2500%, or preferably in a range of from 100 to 2000%, or preferably in a range of from 200 to 1500%, according to DIN EN 13726-1 with a piece of foam with a dimension of 5*5 cm;
F7) A surface roughness in a range of from 200 to 2000 nm, or preferably in a range of from 300 to 1800 nm, or preferably in a range of from 500 to 1500 nm.

The retention capacity (Centrifuge Retention Capacity, CRC) mentioned in F5) is determined according to a test recommended by the EDANA (European Disposables and Nonwovens Association, Avenue Eugene Plasky 157, 1030 Brüssel, Belgien) with the Test No. 441.2-02 “Centrifuge Retention Capacity”.

A further aspect of the invention relates to an envelope, wherein the envelope comprises at least a first layer comprising a polyurethane and a second layer comprising a polyurethane, wherein the first layer and the second layer superimpose each other in a manner that the envelope is formed. The envelope preferably has a shape in form of a hand, a foot, a head, a leg, a knee, an elbow, a body of a human or animal. When in use, the envelope can be placed around the part of the body of a human or an animal, for example a hand, a foot, a head, a leg, a knee, an elbow, a body. Preferably, the first and the second layer are two different pieces which are preferably connected at the edges of the two layers to form the envelope. Preferably, the pieces are cut into the shape of one which are adhered at of the foam.

The present invention is illustrated by reference to examples in form of figures, although these are not to be understood as being limiting. Unless stated otherwise, all of the quantitative data, fractions and percentages are based on the weight and the total amount or on the total weight of the compositions.

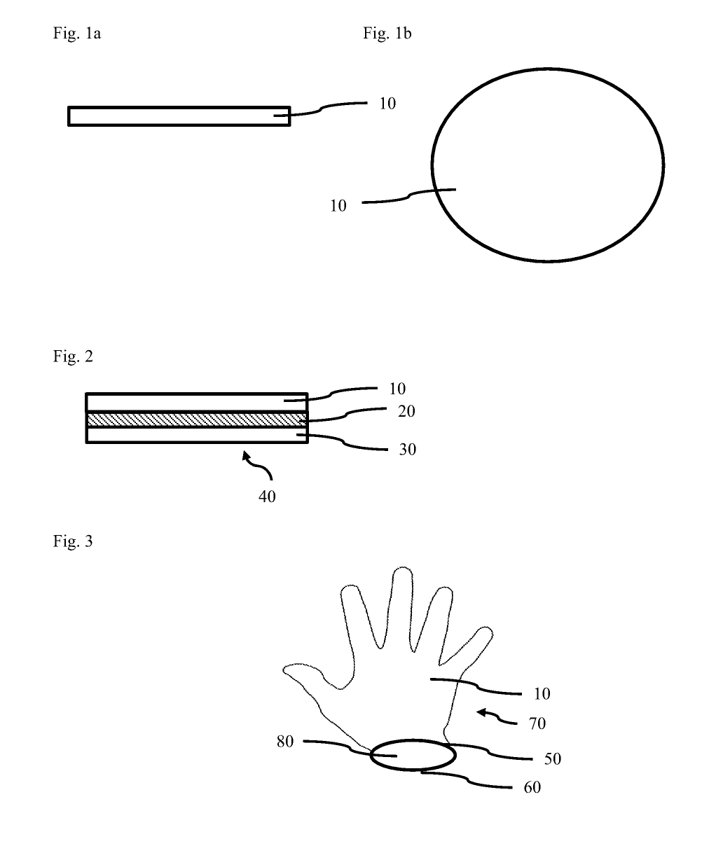

FIG. 1a show a lateral view onto a scheme of a foam according to the invention;

FIG. 1b shows a top view onto a scheme of a foam according to the invention;

FIG. 2 shows a scheme of a layered structure according to the invention;

FIG. 3 shows a scheme of an envelope according to the invention.

In FIG. 1a a lateral view onto a scheme of a foam 10 according to the invention is shown. The foam 10 has a thickness of about 500 μm to 1 mm. The foam comprises a polyurethane in a range of from 80 to 100 wt.-%, based on the total weight of the foam. The foam 10 can be impregnated by a cosmetic component which is transferred to the skin of a user, when the foam is brought into contact to the skin.

In FIG. 1b a top view onto a scheme of a foam 10 according to the invention is shown which is the same foam 10 as shown in FIG. 1a. The diameter of the foam is in a range of 2 to 10 cm.

In FIG. 2 a scheme of a layered structure 40 according to the invention. The layered structure 40 comprises a first foam 10, an interlayer 20 and a second foam 30. The first foam 10 and the second foam 30 can be of the same material and size. As example the first foam 10 has the same dimension as described in FIGS. 1a and 1b. The interlayer 20 is preferably formed as foil 20, e.g. from polycarbonate. The second foam 30 can be of the same material as the first foam 10. One or both foams 10, 30 may be impregnated by a cosmetic component (not shown).

In FIG. 3 a scheme of an envelope according to the invention is shown. The envelope 70 as shown in FIG. 3 has the shape of a hand, but could also be shaped in form of a foot or any other body part of a human. The envelope 70 has two layers 50 and 60 in form of a first layer 50 and a second layer 60. The layers 50 and 60 may be part of one piece of foam 10 or they can be built from two or more pieces of foam 10 which are glued or fused together to form the envelope 70. When utilising the envelope 70, the body part of the user which should be contacted with the foam may be placed in the envelope 70 which can be entered by the opening 80. In the case the foam 10, 30 of envelope 70 has been impregnated by any cosmetic component, the envelope can be used as applicator 70. However, the envelope itself does not have to comprise a cosmetic component.

1.-14. (canceled)

15. A method comprising utilizing a foam comprising a polyurethane for cosmetic applications on the skin or hair of a human or an animal.

16. The method according to claim 15, wherein the polyurethane is a hydrophilic, aliphatic polyurethane.

17. The method according to claim 15, wherein the foam is produced by reacting at least the following components:
A) isocyanate-functional prepolymers, obtainable by reaction of
A1) low molecular weight aliphatic diisocyanates having a molar mass of 140 to 278 g/mol with
A2) di- to hexafunctional, polyalkylene oxides having an OH number of 22.5 to 112, and an ethylene oxide content of 50 to 100 mol %, based on the total amount of oxyalkylene groups present,
B) optionally alkali metal salts containing catalysts or alkali metal salts of weak inorganic acids,
C) water,
D) optionally heterocyclic 4-ring or 6-ring oligomers of low molecular weight aliphatic diisocyanates having a molar mass of 140 to 278 g/mol,
E) optionally further catalysts additionally to component B),
F) optionally surfactants,
G) optionally mono- or polyhydric alcohols, and
H) optionally hydrophilic polyisocyanates obtainable by reaction of component A and/or D) with
H1) monofunctional polyalkylene oxides having an OH number of 10 to 250 and an ethylene oxide content of 50 to 100 mol %, based on the total amount of oxyalkylene groups present, wherein the reaction of component A) and/or D) with component H1) is established before the mixing with component C);
wherein the selected components are delivered, mixed, foamed and cured.

18. The method according to claim 15 wherein the cosmetic application is selected from the group consisting of:
CA1. applying a cosmetic component to the skin or hair via the foam;
CA2. retracting a cosmetic component from the skin or hair via the foam; or
CA3. a combination of CA1. and CA2.

19. The method according to claim 15, wherein the foam provides at least one of the following properties:
F1) a density in a range of from 0.01 to 0.5 g/cm³; or preferably in a range of from 0.05 to 0.45 g/cm³; or in a range of from 0.1 to 0.4 g/cm³;
F2) an tensile strength in a range of from 20 to 100 kPa, or preferably in a range of from 25 to 90 kPa, or in a range of from 30 to 80 kPa; (determined according to DIN 53504);
F3) an elongation at break in a range of from 20 to 100%, or preferably in a range of from 25 to 90%; (determined according to DIN 53455);
F4) a rebound elasticity of greater than 50%, or preferably of greater than 60%, or preferably of greater than 70% (determined according to DIN EN ISO 3386-1);
F5) a water retention capacity in a range of from ≥5 g/g, or preferably ≥10 g/g, or preferably ≥15 g/g, or preferably in a range of from 5 to 20 g/g;
F6) a maximal water absorption rate in a range of from ≥50% to 2500%, or preferably in a range of from 100 to 2000%, or preferably in a range of from 200 to 1500%, according to DIN EN 13726-1 with a piece of foam with a dimension of 5*5 cm;
F7) a surface roughness in a range of from 200 to 2000 nm, or preferably in a range of from 300 to 1800 nm, or preferably in a range of from 500 to 1500 nm.

20. The method according to claim 15, wherein the foam further comprises
I) a superabsorber;
II) a thickener,
III) a diluent,
IV) a filler,
V) a dye.

21. A process for applying a cosmetic component to a skin or hair of a human or animal, comprising at least the following steps:
i. providing a foam comprising a polyurethane;
ii. contacting the foam with a cosmetic component in a way that at least a part of the cosmetic component is in contact with the foam forming an active part of the foam;
iii. contacting the skin or hair of a human or an animal with the active part of the foam in a way that the cosmetic component covers at least a part of the contacted skin;

22. A process for cleaning a part of a skin or hair of a human or an animal, comprising the steps:
I. providing a foam comprising a polyurethane;
II. contacting at least the part of the skin or hair of a human or an animal by the foam which should be cleaned;
III. removing the foam from the skin or hair of the human or the animal.

23. An applicator, comprising at least the following components:
(1) a foam, comprising a polyurethane;
(2) a cosmetic component on a surface of the foam or inside the foam.

24. The applicator, according to claim 23, wherein the cosmetic component is selected from the group consisting of a surfactant, a cream, a powder, a fluid, a pharmaceutical, an oil, a shampoo, a conditioner, a color, a hair color or a combination of at least two thereof

25. A layered structure comprising at least the following layers:
L1st) a first foam comprising a polyurethane;
L2nd) an interlayer;
L3rd) a second foam comprising a polyurethane

26. The layered structure according to claim 25, wherein the interlayer provides at least one of the following properties:
EF1 the interlayer comprises a polyurethane foil,
EF2 the interlayer comprises a non-woven,
EF3 the interlayer comprises a paper,
EF4 the interlayer has a thickness in the range of from 10 μm to 5 mm.

27. The layered structure according to claim 25, wherein the first foam and/or the second foam provides at least one of the following properties:
F1) a density in a range of from 0.01 to 0.5 g/cm³; or preferably in a range of from 0.05 to 0.45 g/cm³; or in a range of from 0.1 to 0.4 g/cm³;
F2) an tensile strength in a range of from 20 to 100 kPa, or preferably in a range of from 25 to 90 kPa, or in a range of from 30 to 80 kPa; (determined according to DIN 53504);
F3) an elongation at break in a range of from 20 to 100%, or preferably in a range of from 25 to 90%; (determined according to DIN 53455);
F4) a rebound elasticity of greater than 50%, or preferably of greater than 60%, or preferably of greater than 70% (determined according to DIN EN ISO 3386-1);
F5) a water retention capacity in a range of from ≥5 g/g, or preferably ≥10 g/g, or preferably ≥15 g/g, or preferably in a range of from 5 to 20 g/g;
F6) a water absorption rate in a range of from ≥50% to 2500%, or preferably in a range of from 100 to 2000%, or preferably in a range of from 200 to 1500%, according to DIN EN 13726-1 with a piece of foam with a dimension of 5*5 cm;
F7) a surface roughness in a range of from 200 to 2000 nm, or preferably in a range of from 300 to 1800 nm, or preferably in a range of from 500 to 1500 nm.

28. An envelope, wherein the envelope comprises at least a first layer comprising a polyurethane and a second layer comprising a polyurethane, wherein the first layer and the second layer superimpose each other in a manner that the envelope is formed.
